(19) United States
(12) Patent Application Publication
(10) Pub. No.: US 2026/0200153 A1
(43) Pub. Date: Jul. 16, 2026

(54) POLYESTER MULTI-LAYER FILM HAVING EXCELLENT TRANSPARENCY AND MANUFACTURING METHOD THEREOF

(71) Applicant: TORAY ADVANCED MATERIALS KOREA INC., Gumi-si (KR)

(72) Inventors: Kil Joong KIM, Gumi-si (KR); Kyu Suk LEE, Gumi-si (KR)

(73) Assignee: TORAY ADVANCED MATERIALS KOREA INC., Gumi-si (KR)

(21) Appl. No.: 19/136,067

(22) PCT Filed: Oct. 13, 2023
(86) PCT No.: PCT/KR2023/015829

§ 371 Date: Jun. 5, 2025

(30) Foreign Application Priority Data
Dec. 7, 2022 (KR) 10-2022-0169849

(51) Int. Cl. B29C 48/00; B29C 48/08; B29C 48/21; B29C 71/02; B29K 67/00; B29K 105/00; B29L 7/00; B29L 9/00

(52) U.S. Cl. CPC B29C 48/0018; B29C 48/022; B29C 48/08; B29C 48/21; B29C 71/02; B29C 2948/92704; B29K 2067/003; B29K 2105/0094; B29K 2995/0053; B29K 2995/0097; B29L 2007/008; B29L 2009/00

(57) ABSTRACT

The present invention relates to a polyester multi-layer film having excellent transparency and a manufacturing method thereof. More specifically, the objective of the present invention is to provide a polyester multi-layer film having excellent transparency and a manufacturing method thereof, in which the transparency and visibility of the film can be maintained even in a high temperature treatment process by suppressing oligomer formation in the film and migration to the surface, a polyester multi-layer film having excellent transparency can be manufactured at a low manufacturing cost, and productivity can be greatly increased by preventing in-process contamination caused by oligomer scattering.

### TECHNICAL FIELD

The present invention relates to a polyester multi-layer film having excellent transparency and a manufacturing method thereof, and more specifically, to a polyester multi-layer film having excellent transparency and a manufacturing method thereof, in which the transparency and visibility of the film can be maintained even in a high temperature treatment process by suppressing formation of oligomers within the film and their migration to the surface.

### BACKGROUND ART

In general, polyester films possess excellent durability, remarkable stability of physical properties across a wide temperature range from low to high temperatures, superior chemical resistance compared to other polymer resins, and good mechanical strength and surface characteristics. Due to these outstanding physical and chemical properties, polyester films are widely used in displays, semiconductors, and other industrial applications. Specifically, their excellent transparency and visibility, along with superior mechanical and electrical properties, have led to a continuous increase in their use as optical films for displays such as LCDs and touch panels.

However, since polyester films require high temperatures of over 100° C. in the process of manufacturing displays and the like, there is a problem in that low-molecular-weight oligomers within the polyester film migrate to the surface, and the oligomers that have migrated to the surface may result in the formation of crystalline foreign substances, known as blooming phenomenon, which not only degrade transparency but also cause contamination due to scattering within the process, thereby reducing productivity.

To prevent oligomers in polyester films from migrating to the surface, methods of reducing the oligomer content through solid-state polymerization during the polymerization of polyester films are widely used. However, the complicated solid-state polymerization process not only increases costs but also fails to completely block oligomers since oligomers are continuously generated within the film at high temperatures and migrate to the surface.

In addition, other methods to prevent oligomer from migrating to the surface include using high-heat-resistant polymers such as polyethylene naphthalate (PEN), or applying copolymers using monomers such as isophthalate or cyclohexane dimethanol instead of terephthalic acid or ethylene glycol. However, these methods may alter the physical properties of the polyester and ultimately fail to suppress the migration of oligomers to the surface.

Moreover, technologies have been reported that form a laminated layer on a polyester film and use high-viscosity polymers obtained through solid-state polymerization in a skin layer to control oligomer migration. However, these methods lack economic feasibility due to the use of expensive catalysts and do not completely block oligomer migration.

### DETAILED DESCRIPTION OF THE INVENTION

### Technical Problem

The present invention was devised to solve the aforementioned problems, and an objective to be achieved by the present invention is to provide a polyester multi-layer film having excellent transparency and a manufacturing method thereof, in which the transparency and visibility of the film can be maintained even in a high temperature treatment process by suppressing formation of oligomers within the film and their migration to the surface.

Another objective of the present invention is to provide a method of manufacturing a polyester multi-layer film having excellent transparency, which can produce a polyester multi-layer film having excellent transparency at low manufacturing cost and can significantly increase productivity by preventing in-process contamination caused by oligomer scattering.

The above and other objectives and advantages of the present invention will become apparent from the following description of preferred embodiments.

### Technical Solutions

The above objective is achieved by a polyester multi-layer film having excellent transparency, which includes a substrate layer including a polyester resin and a skin layer positioned on at least one surface of the substrate layer and including a polyester resin, wherein the polyester multi-layer film satisfies Equation 1 below,

$$110 < 0.013 * [ C 3 ] - Ds * ( 50 / Dt ) < 121 \qquad ( Equation 1 )$$

Here, [C3] denotes a ppm concentration of C3 cyclic oligomers contained in the multi-layer film, Ds denotes a thickness (μm) of the skin layer, and Dt denotes a thickness (μm) of the multi-layer film.

Here, the concentration of C3 cyclic oligomer contained in the polyester multi-layer film may be 9,000 ppm to 9,700 ppm.

Preferably, the concentration of C3 cyclic oligomers in the polyester resin forming the substrate layer may be 9,000 ppm to 12,000 ppm and the concentration of C3 cyclic oligomers in the polyester resin forming the skin layer may be 4,500 ppm to 7,000 ppm.

Preferably, the thickness of the skin layer may be 2 μm to 10 μm.

Preferably, a thickness ratio of the skin layer and the substrate layer is 1:6 to 1:15.

Preferably, the intrinsic viscosity (IV) of the polyester resin forming the skin layer may be 0.60 dl/g to 0.70 dl/g.

Preferably, the skin layer may further include 0.1 to 1.0 parts by weight of an organic phosphorus compound based on 100 parts by weight of the polyester resin.

Preferably, the organic phosphorus compound may be at least one selected from triaryl phosphite and trialkyl phosphite.

Preferably, the polyester multi-layer film, when treated at high temperatures, may exhibit a haze variation (ΔHt) satisfying Equation 2 below:

$$Δ Ht = Hf - Hi < 0.5 \% \qquad ( Equation 2 )$$

Here, Hi denotes haze before heat treatment and Hf denotes haze after heat treatment at 150° C. for 30 minutes.

More preferably, the polyester multi-layer film, when treated at high temperatures after treatment under high-temperature and high-humidity conditions, may exhibit a haze variation (ΔHht) satisfying Equation 3 below:

$$Δ H h t = H e - H s < 1.0 \% \qquad ( Equation 3 )$$

Here, Hs denotes haze before treatment under high-temperature and high-humidity conditions, and He denotes haze after heat treatment at 150° C. for 30 minutes of a film that has been treated under high-temperature and high-humidity conditions at 85° C. and 85% RH for 240 hours.

In addition, the above objective may be achieved by a method of manufacturing a polyester multi-layer film having excellent transparency, the method including: a first step of preparing a polyethylene terephthalate sheet by co-extruding a raw material of a skin layer comprising a polyester resin of a low-oligomer type and a raw material of a substrate layer comprising a polyester resin of a high-oligomer type; a second step of producing a uniaxially stretched polyester multi-layer film by stretching the polyethylene terephthalate sheet 3 to 5 times in a machine direction (MD) and then cooling it to room temperature; a third step of producing a biaxially stretched polyester multi-layer film by stretching the uniaxially stretched polyester multi-layer film 3 to 5 times in a transverse direction (TD); and a fourth step of producing a polyester multi-layer film by heat-treating the biaxially stretched polyester multi-layer film at 230° C. to 250° C. and heat-setting it at 200° C. to 220° C.

Preferably, a concentration of C3 cyclic oligomers in the raw material of the substrate layer may be 9,000 ppm to 12,000 ppm and a concentration of C3 cyclic oligomers in the raw material of the skin layer may be 4,500 ppm to 7,000 ppm.

Preferably, the raw material of the skin layer may further include 0.1 to 1.0 parts by weight of an organic phosphorus compound based on 100 parts by weight of the polyester resin and the organic phosphorus compound may be at least one selected from triaryl phosphite and trialkyl phosphite.

Preferably, the raw material of the skin layer may include an organic phosphorus compound through a master batch chip in which the organic phosphorus compound is compounded separately from the polyester resin of the low-oligomer type.

### Advantageous Effects of the Invention

According to the present invention, the transparency and visibility of a film can be maintained even in a high temperature treatment process by suppressing formation of oligomers within the film and their migration to the surface.

In addition, according to the present invention, a polyester multi-layer film with excellent transparency can be produced at low manufacturing cost, thereby providing advantages such as high economic efficiency.

Furthermore, the present invention, through the above-described advantages, may enable the maintenance of excellent product quality in displays, semiconductors, and various industrial applications, and provide effects such as significantly improving productivity by preventing in-process contamination caused by oligomer scattering.

However, the effects of the present invention are not limited to the effects mentioned above, and other effects not mentioned will be clearly understood by those skilled in the art from the description below.

### BRIEF DESCRIPTION OF DRAWINGS

FIG. 1 is a schematic cross-sectional view of a polyester multi-layer film having excellent transparency according to an embodiment of the present invention.

### MODE FOR INVENTION

Hereinafter, the present invention will be described in detail with reference to embodiments and accompanying drawing. It will be apparent to those skilled in the art that the embodiments are intended only to illustrate the invention in more detail, and the scope of the invention is not limited by those embodiments.

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of the invention, suitable methods and materials are described herein.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

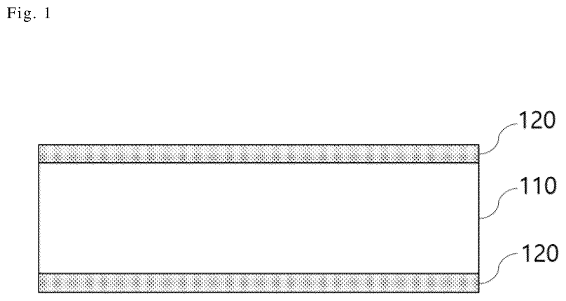

First, a polyester multi-layer film having excellent transparency according to one aspect of the present invention will be described in detail with reference to FIG. 1, which is a schematic cross-sectional view of a polyester multi-layer film having excellent transparency according to a preferred embodiment of the present invention.

Referring to FIG. 1, which is a schematic cross-sectional view of a polyester multi-layer film having excellent transparency according to an embodiment of the present invention, the polyester multi-layer film having excellent transparency according to an embodiment of the present invention includes a substrate layer 110 comprising a polyester resin and skin layers 120 positioned on both surfaces of the substrate layer. The example of FIG. 1 shows that the skin layers 120 are positioned on both surfaces of the substrate layer 110, but the present invention is not limited thereto such that the skin layer 120 may be positioned on only one surface of the substrate 110.

The inventors of the present invention, through efforts to suppress the formation of oligomers within a film and their migration to the surface even at high temperatures, have identified that it is important to inhibit the surface migration of C3 cyclic oligomers, which are representative oligomers. To this end, the inventors have found that it is possible to suppress the formation of oligomers within the film and their migration to the surface by providing a polyester multi-layer film that satisfies Equation 1 below with respect to the C3 oligomer concentration of the entire multi-layer film, the thickness of the skin layer, and the thickness of the multi-layer film, even when a polyester resin having a low oligomer content is used as a raw material for the skin layer 120 and a general-purpose resin is used as a raw material for the substrate layer 110, and based on this finding, the present invention is completed.

$$110 < 0.013 * [ C3 ] - Ds * ( 50 / Dt ) < 121 \qquad ( Equation 1 )$$

Here, [C3] denotes a ppm concentration of C3 cyclic oligomers contained in the multi-layer film, Ds denotes a thickness (μm) of the skin layer, and Dt denotes a thickness (μm) of the multi-layer film.

In this case, when the value of Equation 1 is 110 or less, the thickness of the skin layer using a low-oligomer resin increases, resulting in reduced economic feasibility and decreased productivity, and when it is 121 or more, there is a problem in that the change in haze before and after heat treatment of the film and the change in haze before and after heat treatment of the film subjected to high-temperature and high-humidity treatment become large, and a blooming phenomenon widely appears on the surface of the multi-layer film.

In the polyester multi-layer film having excellent transparency according to an embodiment of the present invention, the concentration (overall concentration) of C3 cyclic oligomers contained in the polyester multi-layer film is preferably 9,000 ppm to 9,700 ppm. In this case, when the overall oligomer concentration is less than 9,000 ppm, the thickness of the skin layer using the low-oligomer resin increases, resulting in insufficient economic feasibility, and when the overall concentration exceeds 9,700 ppm, a sufficient oligomer suppression effect cannot be achieved.

In the polyester multi-layer film having excellent transparency according to an embodiment of the present invention, the concentration of C3 cyclic oligomers forming the substrate layer is preferably 9,000 ppm to 12,000 ppm. In this case, when the oligomer concentration in the polyester resin forming the substrate layer is less than 9,000 ppm, it becomes necessary to use a low-oligomer resin even for the substrate layer, which lacks economic feasibility, and when the concentration exceeds 12,000 ppm, a sufficient oligomer suppression effect cannot be achieved.

In the polyester multi-layer film having excellent transparency according to an embodiment of the present invention, the concentration of C3 cyclic oligomers forming the skin layer is preferably 4,500 ppm to 7,000 ppm. In this case, when the oligomer concentration in the polyester resin forming the skin layer is less than 4,500 ppm, it is difficult to manufacture a low-oligomer resin, and producing a low-oligomer resin that meets such a specification requires high cost, thereby lacking economic feasibility. When the concentration exceeds 7,000 ppm, a sufficient oligomer suppression effect cannot be achieved.

In the polyester multi-layer film having excellent transparency according to an embodiment of the present invention, the thickness of the skin layer is preferably 2 μm to 10 μm. In this case, when the thickness of the skin layer exceeds 10 μm, the thickness of the skin layer using the low-oligomer resin increases, resulting in insufficient economic feasibility, and when the thickness is less than 2 μm, a sufficient oligomer suppression effect cannot be achieved.

In the polyester multi-layer film having excellent transparency according to an embodiment of the present invention, the thickness ratio of the skin layer 120 and the substrate layer 110 is preferably 1:6 to 1:15. In cases where the skin layers are disposed on both surfaces of the substrate layer, as shown in FIG. 1, the thickness refers to the total thickness of both skin layers. In this case, when the thickness ratio of the substrate layer 110 is less than 6, the oligomer migration suppression effect may be favorable, but it is may not be preferably in terms of economic feasibility, and when the ratio exceeds 15, processability may deteriorate or the migration suppression effect may be insufficient, and thus it is not preferable.

In the polyester multi-layer film having excellent transparency according to one embodiment of the present invention, the intrinsic viscosity (IV) of the polyester resin forming the skin layer is preferably 0.60 dl/g to 0.70 dl/g. In this case, when the intrinsic viscosity of the skin layer is less than 0.60 dl/g, it is difficult to obtain a low-oligomer resin, and even if such a resin can be obtained, it is difficult to manufacture it, and producing a low-oligomer resin that meets such a specification requires high cost, thereby lacking economic feasibility. When the intrinsic viscosity exceeds 0.70 dl/g, it becomes difficult to produce a film, resulting in deterioration of processability.

In the polyester multi-layer film having excellent transparency according to an embodiment of the present invention, the polyester resin forming the skin layer may further include 0.1 to 1.0 parts by weight of an organic phosphorus compound based on 100 parts by weight of the polyester resin.

The organic phosphorus compound may act similarly to the C3 cyclic oligomer, maintaining an equilibrium state at high temperatures and thereby suppressing the formation of C3 cyclic oligomers within the film. The organic phosphorus compound may be at least one selected from triaryl phosphite and trialkyl phosphite.

Preferably, the organic phosphorus compound in the skin layer may be introduced in the form of a masterbatch chip in which the organic phosphorus compound is compounded separately from the polyester resin. That is, the raw material of the skin layer may include an organic phosphorus compound through a masterbatch chip in which the organic phosphorus compound is compounded separately from the polyester resin of a low-oligomer type. In this case, using a masterbatch chip prepared by compounding the organic phosphorus compound is advantageous in ensuring accurate content and uniform dispersibility.

The polyester multi-layer film having excellent transparency according to an embodiment of the present invention, when treated at high temperatures, may exhibit a haze variation (ΔHt) satisfying Equation 2 below:

$$Δ H t = Hf - Hi < 0.5 \% \qquad ( Equation 2 )$$

Here, Hi denotes haze before heat treatment and Hf denotes haze after heat treatment at 150° C. for 30 minutes.

In this case, when the haze variation (ΔHt) after high-temperature treatment is 0.5% or more, sufficient transparency cannot be ensured, and thus it is not preferable.

In addition, the polyester multi-layer film having excellent transparency according to an embodiment of the present invention, when treated at high temperatures after treatment under high-temperature and high-humidity conditions, may exhibit a haze variation (ΔHht) satisfying Equation 3 below:

$$Δ H h t = H e - H s < 1.0 \% \qquad ( Equation 3 )$$

Here, Hs denotes haze before treatment under high-temperature and high-humidity conditions, and He denotes haze after heat treatment at 150° C. for 30 minutes of a film that has been treated under high-temperature and high-humidity conditions at 85° C. and 85% RH for 240 hours.

In this case, when the haze variation (ΔHht) after treatment under high-temperature and high-humidity conditions followed by high-temperature treatment is 1.0% or more, sufficient transparency cannot be ensured, and thus it is not preferable.

In the polyester multi-layer film having excellent transparency according to an embodiment of the present invention, the concentration of C3 cyclic oligomers contained in the multi-layer film, as defined in Equation 1, and the haze variation before and after heat treatment are generally closely related. To maintain excellent optical properties of the film, such as transparency, even after heat treatment, it is necessary that the haze variation (ΔHt) after high-temperature treatment, as defined in Equation 2, be 0.5% or less. When the haze variation exceeds 0.5%, the transparency decreases, resulting in deterioration of the optical properties of the film. One possible method for achieving this may be to reduce the oligomer concentration in the film to a very low level may be used. However, this requires, as will be discussed below, the use of solid-state polymerized resin throughout the entire film, which leads to poor economic feasibility. Accordingly, in the present invention, a general-purpose liquid chip is used for the substrate layer 110, while a low-oligomer resin is used only for the skin layer 120, thereby enabling suppression of formation and migration of oligomers while maintaining an overall oligomer concentration in the film similar to that of a film using liquid-phase polymerized resin.

Additionally, if the correlation coefficient between the C3 cyclic oligomer, the thickness of the skin layer, and the thickness of the substrate layer is 110 or less in Equation 1, it is necessary to either produce a resin with a low oligomer content for use or increase the thickness of the skin layer, as will be described below, which poses economic feasibility issues. On the other hand, if the value of Equation 1 is 121 or more, the oligomer content in the multi-layer film is too high or the skin layer is too thin, making it difficult to achieve the haze change required by Equations 2 and 3 after heat treatment under high-temperature conditions, and thus transparency cannot be ensured, and such a configuration is therefore not preferable.

Generally, a polyester film contains a certain amount of oligomers from the time the resin, which serves as the raw material, is polymerized. The amount of oligomers contained in the polyester film varies depending on the polymerization method, but typically, based on the representative C3 cyclic oligomer, approximately 0.5% to 2% is present. These oligomers migrate to the surface when the polyester film is exposed to heat above its glass transition temperature, and due to their high crystallinity, the oligomers that have migrated to the surface remain on the surface as crystalline foreign matter several micrometers (μm) in size. Such oligomer crystals deteriorate the optical properties of the film, such as transparency, and may scatter during film processing, contaminating other objects or products and thereby reducing productivity.

In addition, various methods have been used to suppress the migration of oligomers to the surface in a polyester film. The most widely adopted method is to minimize the initial oligomer content by producing the resin through solid-state polymerization, thereby reducing surface migration even when heat is applied. In particular, resins prepared by solid-state polymerization are known to have higher molecular weight and thus higher intrinsic viscosity, which also contributes to suppressing oligomer migration. Another method involves using a copolymer resin that incorporates a certain portion of monomers such as cyclohexanedimethanol or isosorbide into the polyester molecule, which increases the amorphous region of the polymer, allowing it to accommodate more oligomers and thereby suppressing their migration to the surface. Other known methods include the use of high-cost catalysts such as germanium (Ge) or titanium (Ti) to minimize the formation of oligomers under high-temperature conditions during melt extrusion, and the use of laminated films in which a resin with high intrinsic viscosity is used for a skin layer to suppress migration of oligomer. While these methods are each effective to some extent, it is difficult to fundamentally suppress the migration of newly generated oligomers, as oligomer formation continues under the high-temperature conditions of the film-forming and processing processes.

In contrast, the polyester multi-layer film having excellent transparency according to an embodiment of the present invention may suppress the generation of oligomers and also suppress the migration of generated oligomers to the surface. In the polyester multi-layer film having excellent transparency according to an embodiment of the present invention, when the skin layer has an appropriate oligomer concentration and thickness, migration of oligomers to the surface can be sufficiently suppressed under high-temperature conditions, regardless of the oligomer state of the substrate layer, thereby maintaining transparency. This result indicates that even when a low-oligomer resin is used only in the skin layer 120, which accounts for approximately 10% of the film, the overall oligomer level in the film can be stably maintained and migration of oligomers to the surface can be effectively suppressed.

A method of manufacturing a polyester multi-layer film having excellent transparency according to another embodiment of the present invention includes: a first step of preparing a polyethylene terephthalate sheet by co-extruding a raw material of a skin layer comprising a polyester resin of a low-oligomer type and a raw material of a substrate layer comprising a polyester resin of a high-oligomer type; a second step of producing a uniaxially stretched polyester multi-layer film by stretching the polyethylene terephthalate sheet 3 to 5 times in a machine direction (MD) and then cooling it to room temperature; a third step of producing a biaxially stretched polyester multi-layer film by stretching the uniaxially stretched polyester multi-layer film 3 to 5 times in a transverse direction (TD); and a fourth step of producing a polyester multi-layer film with excellent transparency by heat-treating the biaxially stretched polyester multi-layer film at 230° C. to 250° C. and heat-setting it at 200° C. to 220° C.

In the method of manufacturing a polyester multi-layer film having excellent transparency according to another embodiment of the present invention, duplicate descriptions with the above-described polyester multi-layer film having excellent transparency according one embodiment of the present invention are omitted.

First, in the first step in which a polyethylene terephthalate sheet is prepared by co-extruding a raw material of a skin layer comprising a polyester resin of a low-oligomer type and a raw material of a substrate layer comprising a polyester resin of a high-oligomer type, the concentration of C3 cyclic oligomers in the raw material of the substrate layer is preferably 9,000 ppm to 12,000 ppm and the concentration of C3 cyclic oligomers in the raw material of the skin layer is preferably 4,500 ppm to 7,000 ppm.

In this case, the reason for using different raw materials for the skin layer and the substrate layer is to ensure that, when the skin layer has an appropriate low oligomer concentration and thickness, oligomer migration to the surface can be sufficiently suppressed under high-temperature conditions, and transparency can be maintained, regardless of the oligomer state of the substrate layer, even if the substrate layer comprises a conventional high-oligomer polyester resin. In addition, by using solid chips with high intrinsic viscosity (IV) to reduce the oligomer concentration, and applying them only to the thin skin layer, the use of expensive solid chips in the production of a polyester multi-layer film having excellent transparency can be reduced, thereby contributing to improved economic feasibility.

Additionally, the raw material of the skin layer may further include 0.1 to 1.0 parts by weight of an organic phosphorus compound based on 100 parts by weight of the polyester resin, and the organic phosphorus compound may include at least one selected from triaryl phosphite and trialkyl phosphite. In this case, the organic phosphorus compound may be included through a masterbatch chip in which the organic phosphorus compound is compounded separately from the polyester resin of a low-oligomer type.

Next, the second step is a step of producing a uniaxially stretched polyester multi-layer film by stretching the polyethylene terephthalate sheet 3 to 5 times in the machine direction (MD) and then cooling it to room temperature and the third step is a step of producing a biaxially stretched polyester multi-layer film by stretching the uniaxially stretched polyester multi-layer film 3 to 5 times in the transverse direction (TD).

However, although the stretching process in the manufacturing method of the present invention is described as biaxial stretching, the method of manufacturing a polyester multi-layer film having excellent transparency according to the present invention is not limited to biaxial stretching alone; rather, the film may be manufactured without stretching or by uniaxial stretching, as necessary.

Next, the fourth step is a step of producing a polyester multi-layer film with excellent transparency by heat-treating the biaxially stretched polyester multi-layer film at 230° C. to 250° C. and heat-setting it at 200° C. to 220° C.

In the polyester multi-layer film having excellent transparency manufactured by the above-described method, it is preferable that the haze variation is maintained at 0.5% or less after heat treatment at 150° C. for 30 minutes. In addition, it is preferable that the haze variation is maintained at 1.0% or less after the heat-treatment at 85° C. and 85% RH for 240 hours, followed by heat treatment at 150° C. for 30 minutes. As such, the polyester multi-layer film having excellent transparency according to an embodiment of the present invention offers advantages in that it maintains excellent transparency without oligomer migration even under high temperatures, and also suppresses scattering of oligomers during the manufacturing process, thereby ensuring a cleaner production environment.

Hereinafter, the configuration and effects of the present invention will be described in further detail through Examples and Comparative Examples. However, the following Examples are provided to specifically illustrate the present invention and are not intended to limit the scope of the present invention.

### EXAMPLES

### Preparation Example

### (1) Preparation of Polyester Resins A and B

100 parts by weight of terephthalic acid and 60 parts by weight of ethylene glycol were used as starting materials, magnesium acetate tetrahydrate was added as a catalyst, and the mixture was put into a reactor. The reaction initiation temperature was set to 150° C., and the temperature was gradually increased, reaching 230° C. after 3 hours. After an additional 4 hours, the ester exchange reaction was substantially completed. The reaction mixture was then transferred to a polycondensation reactor, where antimony trioxide was added, and a polycondensation reaction was carried out for 4 hours to obtain polyester resin A having an intrinsic viscosity of 0.61 dl/g and a C3 cyclic oligomer content of 9,990 ppm.

Next, using the polyester resin A obtained above, solid-state polymerization was performed under nitrogen conditions at a temperature of 215° C., and polyester resin B having an intrinsic viscosity of 0.70 dl/g and a C3 cyclic oligomer content of 4,000 ppm was obtained.

### (2) Preparation of Polyester Multi-Layer Film

Polyester resin A, from which moisture had been removed, was used as the raw material for the substrate layer (main layer), and polyester resin B was blended with resin A so that the C3 cyclic oligomer content reached a predetermined level, and the blend was then fed into a co-extruder. The feeder block was adjusted to control the weight ratio of the substrate layer and the skin layer to fall within the range of 6:1 to 15:1, and extrusion was carried out. The extruded material was rapidly cooled and solidified using a casting drum with a surface temperature of 20° C., thereby producing a polyethylene terephthalate sheet having a thickness of 8,000 μm.

Next, the prepared polyethylene terephthalate sheet was stretched 3 to 5 times in the machine direction (MD) at 80° C. and then cooled to room temperature. Thereafter, the sheet was gradually heated inside a tenter, subjected to preheating and drying, and then stretched 3 to 5 times in the transverse direction (TD). Subsequently, heat treatment was performed inside the tenter at 230° C. to 250° C., followed by heat setting at 200° C. to 220° C., thereby producing a biaxially stretched multi-layer film.

### Example 1

Polyester resin A and polyester resin B were blended so that the C3 cyclic oligomer content reached 6,000 ppm, and the blend was used as the raw material for the skin layer. Polyester resin A was used for the substrate layer, and co-extrusion was carried out at 280° C. to produce a polyester multi-layer film having a thickness of 50 μm, in which skin layers with a thickness of 3 μm were formed on both surfaces of the substrate layer. The C3 cyclic oligomer content of the produced polyester multi-layer film, the correlation coefficient according to Equation 1, the haze variation before and after heat treatment at 150° C. for 30 minutes according to Equation 2, and the haze variation before and after treatment under conditions of 85° C. and 85% relative humidity followed by heat treatment according to Equation 3 are shown in Table 1 below (the same applies hereinafter).

### Example 2

A polyester multi-layer film was prepared in the same manner as in Example 1, except that a C3 cyclic oligomer content in the skin layer was set to 4,500 ppm.

### Example 3

A polyester multi-layer film was prepared in the same manner as in Example 1, except that a C3 cyclic oligomer content in the skin layer was set to 6,500 ppm and a thickness of the skin layer was set to 4 μm.

### Example 4

A polyester multi-layer film was prepared in the same manner as in Example 1, except that a thickness of the skin layer was set to 6 μm.

### Example 5

A polyester multi-layer film was prepared in the same manner as in Example 1, except that a C3 cyclic oligomer content in the skin layer was set to 6,500 ppm, a thickness of the skin layer was set to 10 μm, and a thickness of the polyester multi-layer film was set to 100 μm.

### Example 6

A polyester multi-layer film was prepared in the same manner as in Example 1, except that a C3 cyclic oligomer content in the skin layer was set to 4,500 ppm, a thickness of the skin layer was set to 8 μm, and a thickness of the polyester multi-layer film was set to 100 μm.

### Example 7

A polyester multi-layer film was prepared in the same manner as in Example 1, except that a C3 cyclic oligomer content in the skin layer was set to 7,000 ppm, a thickness of the skin layer was set to 8 μm, and a thickness of the polyester multi-layer film was set to 100 μm.

### Example 8

A polyester multi-layer film was prepared in the same manner as in Example 1, except that a thickness of the skin layer was set to 6 μm and a thickness of the polyester multi-layer film was set to 100 μm.

### Example 9

A polyester multi-layer film was prepared in the same manner as in Example 1, except that a C3 cyclic oligomer content in the skin layer was set to 4,500 ppm, a thickness of the skin layer was set to 2 μm, and a thickness of the polyester multi-layer film was set to 30 μm.

### Example 10

A polyester multi-layer film was prepared in the same manner as in Example 1, except that a C3 cyclic oligomer content in the skin layer was set to 6,500 ppm and a thickness of the polyester multi-layer film was set to 38 μm.

### Example 11

A polyester multi-layer film was prepared in the same manner as in Example 1, except that a C3 cyclic oligomer content in the skin layer was set to 6,500 ppm, a 5% masterbatch of an organic phosphorus compound was used so that the phosphorus content in the skin layer reached 250 ppm, a thickness of the skin layer was set to 3 μm, and a thickness of the polyester multi-layer film was set to 50 μm.

### COMPARATIVE EXAMPLES

### Comparative Example 1

A polyester multi-layer film was prepared in the same manner as in Example 1, except that a C3 cyclic oligomer content in the skin layer was set to 4,500 ppm and a thickness of the skin layer was set to 2 μm.

### Comparative Example 2

A polyester multi-layer film was prepared in the same manner as in Example 1, except that a C3 cyclic oligomer content in the skin layer was set to 7,000 ppm.

### Comparative Example 3

A polyester multi-layer film was prepared in the same manner as in Example 1, except that a C3 cyclic oligomer content in the skin layer was set to 5,000 ppm, a thickness of the skin layer was set to 7 μm, and a thickness of the polyester multi-layer film was set to 50 μm.

### Comparative Example 4

A polyester multi-layer film was prepared in the same manner as in Example 1, except that a C3 cyclic oligomer content in the skin layer was set to 8,500 ppm, a thickness of the skin layer was set to 7 μm, and a thickness of the polyester multi-layer film was set to 100 μm.

### Comparative Example 5

A polyester multi-layer film was prepared in the same manner as in Example 1, except that a C3 cyclic oligomer content in the skin layer was set to 8,500 ppm, a thickness of the skin layer was set to 6 μm, and a thickness of the polyester multi-layer film was set to 100 μm.

### Comparative Example 6

A polyester multi-layer film was prepared in the same manner as in Example 1, except that a C3 cyclic oligomer content in the skin layer was set to 7,500 ppm, a thickness of the skin layer was set to 2 μm, and a thickness of the polyester multi-layer film was set to 38 μm.

The physical properties of the polyester multi-layer films prepared in Examples 1 to 11 and Comparative Examples 1 to 6 were measured through the following experimental examples, and the results are shown in Table 1.

### Experimental Examples

### (1) Measurement of C3 Cyclic Oligomer Content

After dissolving 50 mg of the prepared multi-layer films in 1 ml of 1,1,1,3,3,3-hexafluoro-2-propanol, it was reprecipitated by adding 10 ml of chloroform and 8 ml of methanol. After filtration through a 5 μm filter, the solvent was removed. The resulting precipitate was dissolved in a predetermined amount of chloroform, and the amount of C3 cyclic oligomers was measured using an HPLC (1200 series from Agilent Technologies, Inc.).

Here, the amount of oligomers measured using HPLC was obtained from the commonly used peak area ratio of the standard sample peak area to the measurement sample peak area (absolute calibration method). The column used was Polaris 5 Si 100*4.6 mm, the temperature was maintained at 40° C., the mobile phase was a hexane/1,4-dioxane mixture (at a weight ratio of 6:4), the flow rate was set to 1.0 ml/min, and a 240 nm UV detector was used.

### (2) Measurement of Haze Difference (ΔHt) Before and After Heat Treatment

The haze of the film was measured using an NDH-5000 model turbidimeter (from Nippon Denshoku Industries Co., Ltd.) in accordance with ASTM-D1003, based on films prepared as samples.

First, the haze (Hi) of the film prepared as a sample was measured, then the prepared film sample was fixed onto a rectangular metal support and subjected to heat treatment in an oven at 150° C. for 30 minutes. Then the haze (Hf) after heat treatment was measured.

The haze difference (ΔHt) before and after heat treatment was calculated by subtracting the haze (Hi) before heat treatment from the haze (Hf) after heat treatment.

### (3) Measurement of Haze Difference (ΔHht) Before and After Heat Treatment of Film Subjected to Treatment at High Temperature and High Humidity

The haze of the film was measured using an NDH-5000 model turbidimeter (from Nippon Denshoku Industries Co., Ltd.) in accordance with ASTM-D1003, based on films prepared as samples.

First, the haze (Hs) of the film prepared as a sample was measured, and then the film was left to stand under conditions of 85° C. and 85% RH for 240 hours. Afterwards, the film was heat-treated at high temperature by leaving it in an oven at 150° C. for 30 minutes, and then the haze (He) of the film treated at high temperature and high humidity was measured.

The haze difference (ΔHht) before and after heat treatment of the film subjected to treatment at high temperature and high humidity was calculated by subtracting the haze (Hs) before high-treatment and high-humidity treatment from the haze (He) after heat treatment of the film subjected to high-temperature and high-humidity treatment.

### (4) Measurement of Skin Layer Thickness

The film prepared as a sample was microtomed using a microtome (LEICA RM2255) for cross-sectional preparation, followed by platinum coating. The thickness was then measured using a scanning electron microscope (SEM, HITACHI S-4800).

### (5) Surface State Analysis by Optical Microscope

The film prepared as a sample was fixed onto a rectangular metal support and subjected to heat treatment by standing in an oven at 150° C. for 30 minutes. The film after the high-temperature heat treatment and the film before the heat treatment were analyzed using an optical microscope (from Olympus corporation, MX50LT-1273MH) in a surface area of 2 mm×2 mm. The surface state was evaluated based on the presence or absence of blooming caused by micron-scale or larger oligomer crystals, according to the following criteria:
O: Not observed at all
Δ: Vaguely observed
X: Widely observed across the surface

The physical properties of the multi-layer films prepared in the above Examples and Comparative Examples are summarized in Table 1. In Table 1, [C3] represents the concentration of C3 cyclic oligomers in the entire multi-layer film.

TABLE 1

| | | | | ΔHt | ΔHht | Correlation | |
|---|---|---|---|---|---|---|---|
| | Dt | [C3] | Ds | (%) | (%) | coefficient | Surface |
| Sample | (μm) | (ppm) | (μm) | (Equation 2) | (Equation 3) | (Equation 1) | state |
| Example 1 | 50 | 9511 | 3 | 0.45 | 0.55 | 120.6 | ◯ |
| Example 2 | 50 | 9331 | 3 | 0.30 | 0.50 | 118.3 | ◯ |
| Example 3 | 50 | 9431 | 4 | 0.33 | 0.45 | 118.6 | ◯ |
| Example 4 | 50 | 9032 | 6 | 0.21 | 0.43 | 111.4 | ◯ |
| Example 5 | 100 | 9292 | 10 | 0.12 | 0.34 | 115.8 | ◯ |
| Example 6 | 100 | 9112 | 8 | 0.15 | 0.33 | 114.5 | ◯ |
| Example 7 | 100 | 9511 | 8 | 0.21 | 0.39 | 119.7 | ◯ |
| Example 8 | 100 | 9511 | 6 | 0.25 | 0.43 | 120.6 | ◯ |
| Example 9 | 30 | 9459 | 2 | 0.48 | 0.92 | 119.6 | ◯ |
| Example 10 | 38 | 9439 | 3 | 0.47 | 0.68 | 118.8 | ◯ |
| Example 11 | 50 | 9511 | 3 | 0.02 | 0.11 | 120.6 | ◯ |
| Comparative | 50 | 9551 | 2 | 0.77 | 2.45 | 122.2 | Δ |
| Example 1 | | | | | | | |
| Comparative | 50 | 9631 | 3 | 4.78 | 6.77 | 122.2 | X |
| Example 2 | | | | | | | |
| Comparative | 50 | 8873 | 7 | 0.37 | 0.74 | 108.3 | ◯ |
| Example 3 | | | | | | | |
| Comparative | 100 | 9781 | 7 | 2.57 | 5.33 | 123.7 | Δ |
| Example 4 | | | | | | | |
| Comparative | 100 | 9691 | 6 | 6.22 | 9.43 | 123.0 | X |
| Example 5 | | | | | | | |
| Comparative | 38 | 9597 | 2 | 4.38 | 7.66 | 122.1 | X |
| Example 6 | | | | | | | |

As shown in Table 1, the polyester multi-layer film according to the present invention exhibits a correlation coefficient (Equation 1) between the C3 cyclic oligomer concentration, the thickness of the skin layer, and the thickness of the multi-layer film, and satisfies the haze variation before and after heat treatment (Equation 2) as well as the haze variation under high-temperature and high-humidity conditions (Equation 3). Accordingly, the film not only demonstrates excellent transparency, but it can also be confirmed that oligomer migration to the surface does not occur. Through this, the polyester multi-layer film that can fundamentally prevent any reduction in productivity caused by external scattering of oligomers can be provided. Furthermore, as shown in Example 11, it was confirmed that the oligomer suppression effect can be further enhanced by using an organic phosphorus compound in the skin layer.

In contrast, in Comparative Examples 1 to 2 and 4 to 6, where the correlation coefficient (Equation 1) is 121 or more, it can be seen that the haze variation before and after heat treatment, as well as the haze variation before and after heat treatment of the film subjected to high-temperature and high-humidity treatment, is large, and blooming appears widely on the surface. In addition, as shown in Comparative Example 3, when the correlation coefficient is 110 or less, although the haze variation before and after heat treatment and the haze variation before and after heat treatment of the film subjected to high-temperature and high-humidity treatment are small, the thickness of the skin layer using low-oligomer resin becomes relatively large compared to the overall thickness, resulting in poor economic feasibility and reduced productivity, which is therefore undesirable.

As described above, the polyester multi-layer film having excellent transparency according to the present invention offers advantages in that, to reduce the oligomer concentration, solid chips having high intrinsic viscosity (IV) are used, but only in the thin skin layer, thereby reducing the use of expensive solid chips in the production of a polyester multi-layer film having excellent transparency and ensuring economic feasibility.

The embodiments provided throughout the present disclosure are only some of various examples performed by the inventors of the present invention. However, the present invention should not be construed as being limited to the embodiments set forth herein. It will be apparent to those skilled in the art that various modifications and variation can be made in the present invention without departing from the spirit or scope of the invention.

1. A polyester multi-layer film having excellent transparency, comprising:
a substrate layer comprising a polyester resin; and
a skin layer comprising a polyester resin and located on at least one surface of the substrate layer,
wherein the polyester multi-layer film satisfies Equation 1 below:
$$110 < 0.013 * [ C3 ] - Ds * ( 50 / Dt ) < 121 \qquad ( Equation 1 )$$
where [C3] denotes a ppm concentration of C3 cyclic oligomers contained in the multi-layer film, Ds denotes a thickness (μm) of the skin layer, and Dt denotes a thickness (μm) of the multi-layer film.

2. The polyester multi-layer film of claim 1, wherein the concentration of C3 cyclic oligomers contained in the polyester multi-layer film is 9,000 ppm to 9,700 ppm.

3. The polyester multi-layer film of claim 1, wherein a concentration of C3 cyclic oligomers in the polyester resin forming the substrate layer is 9,000 ppm to 12,000 ppm and
a concentration of C3 cyclic oligomers in the polyester resin forming the skin layer is 4,500 ppm to 7,000 ppm.

4. The polyester multi-layer film of claim 1, wherein the thickness of the skin layer of 2 μm to 10 μm.

5. The polyester multi-layer film of claim 1, wherein a thickness ratio of the skin layer and the substrate layer is 1:6 to 1:15.

6. The polyester multi-layer film of claim 1, wherein an intrinsic viscosity (IV) of the polyester resin forming the skin layer is 0.60 dl/g to 0.70 dl/g.

7. The polyester multi-layer film of claim 1,
wherein the skin layer further comprises 0.1 to 1.0 parts by weight of an organic phosphorus compound based on 100 parts by weight of the polyester resin.

8. The polyester multi-layer film of claim 7, wherein the organic phosphorus compound is at least one selected from triaryl phosphite and trialkyl phosphite.

9. The polyester multi-layer film of claim 1, wherein the polyester multi-layer film, when treated at high temperatures, exhibits a haze variation (ΔHt) satisfying Equation 2 below:
$$Δ H t = Hf - Hi < 0.5 \% , \qquad ( Equation 2 )$$
where Hi denotes haze before heat treatment and Hf denotes haze after heat treatment at 150° C. for 30 minutes.

10. The polyester multi-layer film of claim 1, wherein the polyester multi-layer film, when treated at high temperatures after treatment under high-temperature and high-humidity conditions, exhibits a haze variation (ΔHht) satisfying Equation 3 below:
$$Δ H h t = H e - H s < 1.0 \% , \qquad ( Equation 3 )$$
where Hs denotes haze before treatment under high-temperature and high-humidity conditions, and He denotes haze after heat treatment at 150° C. for 30 minutes of a film that has been treated under high-temperature and high-humidity conditions at 85° C. and 85% RH for 240 hours.

11. A method of manufacturing a polyester multi-layer film having excellent transparency, the method comprising:
a first step of preparing a polyethylene terephthalate sheet by co-extruding a raw material of a skin layer comprising a polyester resin of a low-oligomer type and a raw material of a substrate layer comprising a polyester resin of a high-oligomer type;
a second step of producing a uniaxially stretched polyester multi-layer film by stretching the polyethylene terephthalate sheet 3 to 5 times in a machine direction (MD) and then cooling it to room temperature;
a third step of producing a biaxially stretched polyester multi-layer film by stretching the uniaxially stretched polyester multi-layer film 3 to 5 times in a transverse direction (TD); and
a fourth step of producing a polyester multi-layer film with excellent transparency by heat-treating the biaxially stretched polyester multi-layer film at 230° C. to 250° C. and heat-setting it at 200° C. to 220° C.

12. The method of claim 11, wherein a concentration of C3 cyclic oligomers in the raw material of the substrate layer is 9,000 ppm to 12,000 ppm and
a concentration of C3 cyclic oligomers in the raw material of the skin layer is 4,500 ppm to 7,000 ppm.

13. The method of claim 11, wherein the raw material of the skin layer further comprises 0.1 to 1.0 parts by weight of an organic phosphorus compound based on 100 parts by weight of the polyester resin and
the organic phosphorus compound is at least one selected from triaryl phosphite and trialkyl phosphite.

14. The method of claim 11, wherein the raw material of the skin layer includes an organic phosphorus compound through a master batch chip in which the organic phosphorus compound is compounded separately from the polyester resin of the low-oligomer type.
